(19) United States
(12) Patent Application Publication
(10) Pub. No.: US 2020/0265418 A1
(43) Pub. Date: Aug. 20, 2020

(54) ELECTRONIC DEVICE AND METHOD FOR PROVIDING DIGITAL SIGNATURE SERVICE OF BLOCK CHAIN USING THE SAME

(71) Applicant: SAMSUNG ELECTRONICS CO., LTD., Suwon-si (KR)

(72) Inventors: Youna LEE, Suwon-si (KR); Jongkeun CHOI, Suwon-si (KR); Sungjin PARK, Suwon-si (KR); Wooseok JANG, Suwon-si (KR); Seongmin JE, Suwon-si (KR); Seungmin HA, Suwon-si (KR)

(21) Appl. No.: 16/794,557

(22) Filed: Feb. 19, 2020

(30) Foreign Application Priority Data
Feb. 19, 2019 (KR) 10-2019-0019534

(51) Int. Cl. G06Q 20/36; H04L 9/06; G06Q 20/38; G06F 21/53; G06Q 20/40

(52) U.S. Cl. CPC G06Q 20/3672; H04L 9/0637; G06Q 20/40145; G06Q 20/3825; G06F 21/53; G06Q 20/3674

(57) ABSTRACT

An electronic device may include: a communication circuit configured to communicate with an external electronic device, a display, a memory, and at least one processor electrically connected to the communication circuit, the display, and the memory, wherein the at least one processor is configured to operate a normal OS and a secure OS, and the memory stores instructions which, when executed, cause the at least one processor to control the electronic device to: receive a signature request message corresponding to a block chain through the communication circuit in the normal OS, drive block chain management software in response to receiving the signature request message, transfer the signature request message to the secure OS through the block chain management software, configure a user authentication request screen based on a trusted application being driven in the secure OS to output the user authentication request screen to the display, create a digital signature on the signature request message in the secure OS reflecting a private key stored in the memory in response to receiving a user authentication input for the digital signature, and transfer the digitally signed message to an application related to a block chain network in the normal OS through the block chain management software.

### CROSS-REFERENCE TO RELATED APPLICATION

This application is based on and claims priority under 35 U.S.C. § 119 to Korean Patent Application No. 10-2019-0019534, filed on Feb. 19, 2019, in the Korean Intellectual Property Office, the disclosure of which is incorporated by reference herein in its entirety.

### BACKGROUND

### Field

The disclosure relates to an electronic device and a method for providing a digital signature service, and for example, to a method for providing a digital signature service of a block chain using an electronic device during an electronic transaction based on the block chain.

### Description of Related Art

Digital signature may refer to a technology to prevent alteration of an electronic document or digital data and to identify the subject that has created a signature, and it has been used for an electronic document exchange or an electronic commerce based on an information communication network.

Recently, a block chain technology has been applied in various fields, whereby a block is created through collaboration of all users who take part in the network, the same block is possessed by all participants through verification and approval of the created block, and data forgery by some users is prevented. The block chain is the technology to maintain security and integrity in a distributed network environment having no centralized server, and as an example, it has been used for digital currency or cryptocurrency services.

As an example of a block chain, an ethereum network is a platform in which an application for performing smart contracts for electronic money can be registered and executed. In the ethereum platform, all participant nodes (e.g., ethereum clients) may verify transactions through transaction books, and they may approve the transactions based on the result of the verification. Further, the block chain technology may interlock with a digital wallet that takes custody of cryptocurrency and manages user information and encrypted keys.

A digital wallet may provide an electronic transaction service based on a private key having all access authorities for the encrypted contents and a public key capable of verifying the authenticity of data in symmetry with the private key. Due to the characteristics of the ethereum network that does not store user information, it is important to manage a private key during the use of a block chain service, and various methods for managing the private key have been proposed. For example, there may be a method for using a digital wallet of a transaction site through online in the block chain service. Further, in order for a private user to manage the private key, there may be a method for storing the private key in a private electronic device or cloud connected to a network or a method for storing the private key in a device that disconnects from the online (e.g., USB or hardware wallet device). However, in the case of storing the private key in a separate storage device, it may be necessary to possess such a separate storage device whenever needed or it may be difficult to manage the storage device against the loss thereof. Accordingly, there is a need for schemes capable of safely managing the private key more conveniently and easily during the block chain electronic transactions.

### SUMMARY

Embodiments of the disclosure provide a method and apparatus to strengthen the security and reliability for a signature procedure in a digital signature service.

According to various example embodiments, an electronic device may include a communication circuit configured to communicate with an external electronic device, a display, a memory, and at least one processor electrically connected to the communication circuit, the display, and the memory, wherein the at least one processor is configured to operate a normal OS and a secure OS, and the memory stores instructions which, when executed, cause the at least one processor to control the electronic device to: receive a signature request message corresponding to a block chain through the communication circuit in the normal OS, drive block chain management software in response to receiving the signature request message, transfer the signature request message to the secure OS through the block chain management software, configure a user authentication request screen based on a trusted application being driven in the secure OS to output the user authentication request screen to the display, create a digital signature on the signature request message in the secure OS reflecting a private key stored in the memory in response to receiving a user authentication input for the digital signature, and transfer the digitally signed message to an application related to a block chain network in the normal OS through the block chain management software.

According to various example embodiments, a method for a digital signature service based on a block chain of an electronic device, is provided, the method comprising: receiving, by a processor of the electronic device, a signature request message corresponding to the block chain through a communication module in a normal OS, driving block chain management software in response receiving the signature request message, transferring the signature request message from the normal OS to a secure OS through the block chain management software, configuring a user authentication request screen corresponding to the signature request message through a trusted application being driven in the secure OS to output the user authentication request screen to a display, receiving a user authentication input for a digital signature, creating the digital signature on the signature request message reflecting a private key stored in the electronic device in response to receiving the user authentication input in the secure OS and transferring the digitally signed message to an application related to a block chain network operating in the normal OS through the block chain management software, wherein the secure OS is operated separately from the normal OS under the control of the processor.

According to various example embodiments, the electronic device can provide a digital wallet service that provides a cold wallet characteristic to guarantee the security through network blocking by creating the digital signature through automatic calling of the private key in a secure world (or domain) during the electronic transactions based on the distributed network (e.g., block chain network or ethereum network) without a separate private key management device.

According to various example embodiments, it is possible to strengthen the security and reliability for the signature procedure by requesting host information of the service that uses the block chain network or the block chain application program during the block chain network transactions, providing the host information together with signature request information to the user during the signature authentication, and creating the electronic signature in response to the user authentication input in the secure environment.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example electronic device according to various embodiments;

FIG. 3 is a block diagram illustrating an example rich execution environment (REE) and a trusted execution environment (TEE) being operated in an electronic device according to various embodiments;

FIG. 4 is a diagram illustrating an example interface between elements of an electronic device for digital signature according to various embodiments;

FIG. 5 is a signal flow diagram illustrating example data flow for a block chain based digital signature service of an electronic device according to various embodiments;

FIG. 6 is a flowchart illustrating an example method for a digital signature service based on a block chain of an electronic device according to various embodiments;

FIGS. 7A and 7B are diagrams illustrating examples of a digital signature authentication request screen of an electronic device according to various embodiments; and

FIG. 8 is a signal flow diagram illustrating example operations between a distributed network device and an electronic device according to various embodiments.

### DETAILED DESCRIPTION

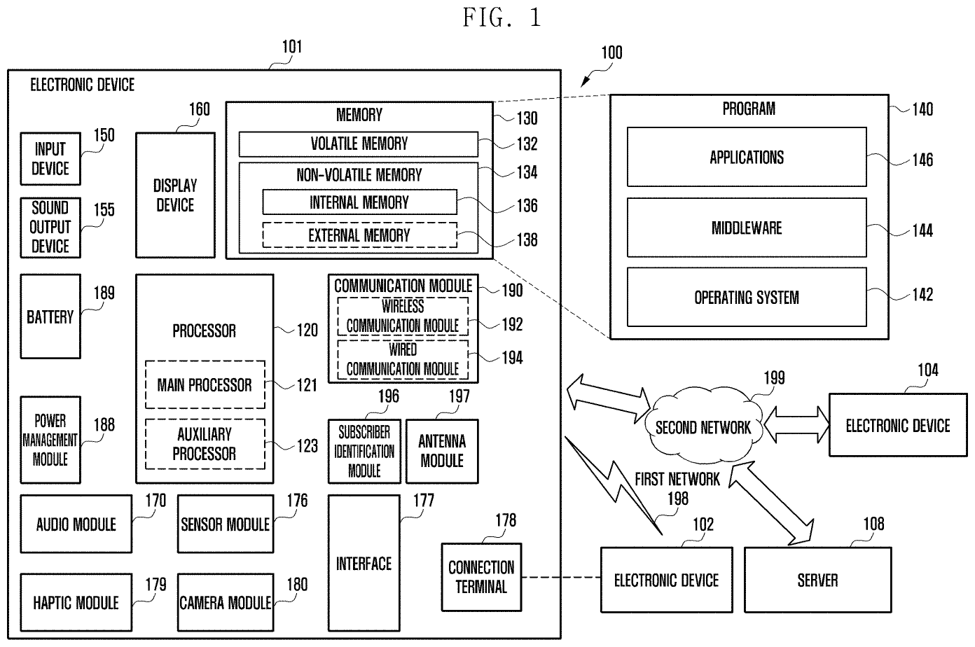

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an example embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an example embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

According to various embodiments, the first network 198 or the second network 199 may be a block chain network. The electronic device 101 may operate in a block chain network environment. The block chain network means a peer-to-peer (P2P) distributed network composed of a plurality of nodes, for example, an ethereum network, but it is not limited thereto.

A plurality of nodes that take part in the block chain network may be connected to one another to communicate with one another, and each of the nodes may store a part or the whole of the block chain. The nodes may refer, for example, to all computing devices (e.g., electronic devices) connected to the block chain network. A block is composed of a hash function that is used by cryptocurrency.

Some of the nodes may perform a mining process to search for hashes through substitution for functions one by one using computing capability of a computer. The node may perform at least one function of a digital wallet, a block chain database, a verification engine, or a P2P network distribution (broadcast).

As an example, an electronic device may take part in the block chain network through at least one type of a reference client, a full node, a mining node, or a lightweight wallet node. The reference client may refer, for example, to a node including a users' digital wallet management module, a mining module for block mining, a block chain database storing all or some blocks of the whole block chain, and a network routing module broadcasting transactions to the block chain distributed network. The full node may refer, for example, to a node including the block chain database and the network routing module. A solo miner node may refer, for example, to a node including the mining module, the block chain database, and the network routing module. The mining node may refer, for example, to a lightweight node including a gateway router connected to a pool mining node and the mining module. The lightweight wallet node may refer, for example, to a lightweight node which may store only header information of the block chain, possesses a digital wallet management module to store a user's digital wallet, and depends on a node owned by a third party in order to create the transactions or to access the block chain network because it does not include the block chain database.

Hereinafter, the electronic device according to various example embodiments may be a node that can store the user's digital wallet and can take part in the block chain network, but it is not limited thereto. The electronic device may take part in the block chain network in other methods.

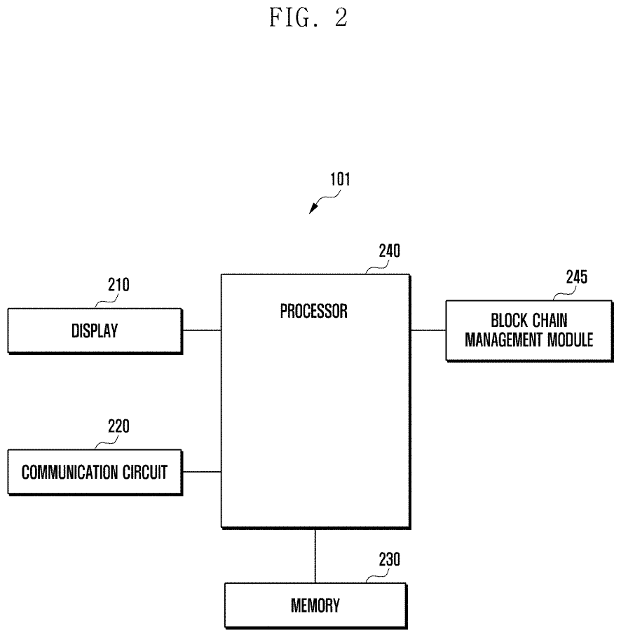

FIG. 2 is a block diagram illustrating an example electronic device according to various embodiments of the disclosure.

With reference to FIG. 2, an electronic device 101 according to various embodiments (e.g., electronic device 101 of FIG. 1) may include a display 210 (e.g., display device 160 of FIG. 1), a communication circuit 220 (e.g., communication module 190 of FIG. 1), a memory 230 (e.g., memory 130 of FIG. 1), and a processor (e.g., including processing circuitry) 240 (e.g., processor 120 of FIG. 1). Some of the elements of FIG. 1 may be added to the electronic device 101.

According to an embodiment, the electronic device 101 may further include a block chain management module (e.g., including various processing circuitry and/or executable program elements) 245. The block chain management module 245 may be driven by block chain management software (SW) (e.g., block chain keystore).

The display 210 may output information related to a block chain network under the control of the processor 240. Under the control of the processor 240, the display 210 may output data being processed by a normal OS and data being processed by a secure OS.

The communication circuit 220 may transmit and receive data based on the block chain network. As an example, the block chain network may be an ethereum network, but it is not limited thereto.

According to an embodiment, under the control of the processor 240, the communication circuit 220 may transmit smart contracts to the block chain network. The smart contracts transmitted to the block chain may be synchronized with all nodes in the block chain, and the contents of the smart contracts may be made public to the all nodes in the block chain. The smart contracts may include, for example, automated contract technology, and may refer, for example, to a computer transaction protocol executing contract conditions. For example, the smart contracts may refer, for example, to a digital contract method for coding the contract conditions based on the block chain technology and carrying out the contract contents if the contract contents coincide with the conditions.

According to an embodiment, the communication circuit 220 may receive block chain data (e.g., message) from the block chain network, and it may transmit data signed with a private key stored in the electronic device 101 (e.g., message with a digital signature) to the block chain network.

The memory 230 may store information related to the block chain therein. For example, the memory 230 may store, for example, and without limitation, at least one of a distributed application capable of accessing to the block chain network, a cryptocurrency wallet application, a block chain trusted application, or a secure user interface application. As an example, the distributed application and the cryptocurrency wallet application may operate in a rich execution environment (REE), whereas the block chain trusted application and the secure user interface application may operate in a trusted execution environment (TEE). During the operation of the secure OS, data may be stored in an encrypted state.

The electronic device 101 may include a separate secure storage region (e.g., embedded secure element (eSE) or embedded subscriber identity module (eSIM)) for block chain management in the memory 230.

According to an embodiment, the memory 230 may store block chain management software (SW). The block chain management software may include, for example, software (e.g., android package kit (APK) file) being applied to a portable device, such as a smart phone. The block chain management software may be built or installed in the electronic device 101. Further, the block chain management software may be downloaded from a server through an app store to be installed in the electronic device.

The processor 240 may include various processing circuitry and perform control of respective elements of the electronic device 101 and/or a communication-related operation or data process. The processor 240 may include at least a part of the configuration and/or function of the processor 120 of FIG. 1. The processor 240 may control the operation of the block chain management module 245 based on the block chain management software.

According to an embodiment, the processor 240 may separately operate the normal OS and the secure OS. A resource zone being operated if the processor 240 is driven by the normal OS may be understood as a normal world, and a resource region being operated if the processor 240 is driven by the secure OS may be understood as a secure world.

According to an embodiment, the processor 240 may perform, for example, and without limitation, access, approval, transaction operations, or the like, of the block chain network by controlling at least one of the block chain management software, cryptocurrency application, or distributed application.

According to an embodiment, under the control of the processor 240, the block chain management module 245 may operate through the block chain management software. The block chain management module 245 may interlock with a block chain network related application, and it may process data of the block chain trusted application and the secure user interface application, which operate in the secure OS. The block chain management module 245 may be understood to include the block chain management software.

According to an embodiment, the block chain management module 245 may create a public key and a private key that are used in the block chain network by applying an encryption algorithm based on a block chain message during a wallet account through the cryptocurrency wallet application.

According to another embodiment, the block chain management module 245 may create the public key and the private key that are used in the block chain network by applying the encryption algorithm based on user's personal information configured in the electronic device 101 and the block chain message when creating the wallet account. The user's personal information may, for example, and without limitation, be at least one of password configuration information, fingerprint authentication information, iris authentication information, face authentication, pattern authentication information, or the like, but it is not limited thereto.

The block chain management module 245 may create a pair of a public key and a private key. The private key created by the block chain management module 245 may be stored or written in the block chain management software. The public key may be transferred to the block chain network through the cryptocurrency wallet application and the distributed application.

According to an embodiment, the block chain management module 245 may create the digital signature for the message transferred through the cryptocurrency wallet application through reflection of the private key stored based on the encryption algorithm in the secure world.

According to an embodiment, the block chain management module 245 may configure a user authentication request screen for identifying user's signature authentication based on the signature authentication request message transferred to the secure world, and it may control the display 210 to output the user authentication request screen. The block chain management module 245 may receive the user authentication input, and it may create the digital signature for the signature authentication request message through reflection of the private key stored in the secure region of the memory in response to the user authentication input information.

According to an embodiment, if the user's personal information is included in the user authentication input information, the block chain management module 245 may create the digital signature under the condition that coincides with the configured user's personal information.

If the condition does not coincide with the user's personal information, the block chain management module 245 may not create the digital signature or may create the digital signature with information that is different from the private key corresponding to the public key. If the digital signature is wrong, the block chain may recognize that the user account of the electronic device 101 is not a rightful participant through the wrongly signed message.

According to an embodiment, the block chain management module 245 may transfer the digitally signed message to the cryptocurrency wallet application that operates in a normal region of the memory.

According to an embodiment, the processor 240 may transfer the digitally signed message that is transferred to the cryptocurrency wallet application to the block chain network through the distributed application. If the participant verification in the block chain network is completed, the electronic device 101 may use the block chain network service.

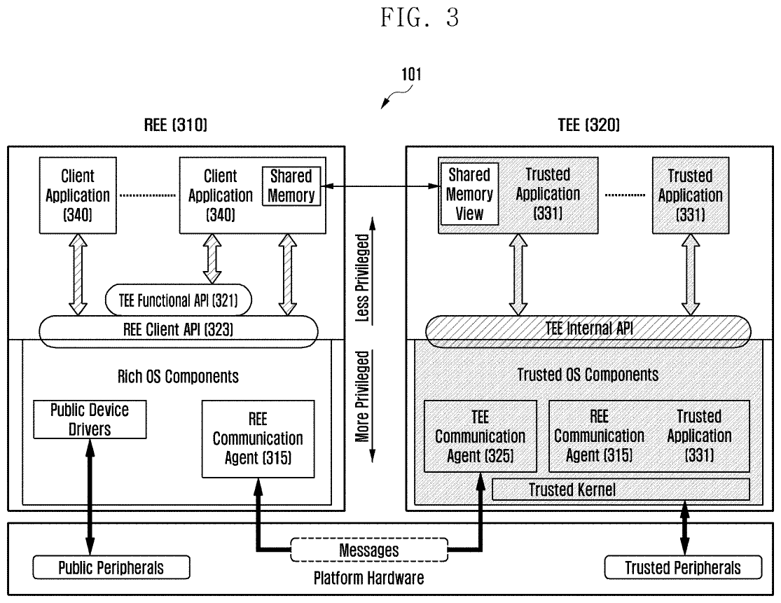

FIG. 3 is a block diagram illustrating an example rich execution environment (REE) and an example trusted execution environment (TEE) being operated in an electronic device according to various embodiments.

With reference to FIG. 3, an electronic device 101 according to various embodiments (e.g., electronic device 101 of FIGS. 1 and 2) may operate an execution environment having a plurality of secure levels for strengthening security. The plurality of execution environments may include, for example, REE 310 and TEE 320. The REE 310 may, for example, be a first execution environment having a first secure level. The TEE 320 may, for example, be a second execution environment having a second secure level that is different from (e.g., higher than) the first secure level. According to another embodiment, the electronic device 101 may include another additional execution environment (e.g., third execution environment) having a third secure level, but the additional execution environment is not limited thereto.

The electronic device 101 may operate the operating system (OS) to be separated into the REE 310 and the TEE 320. The REE 310 may be driven in a normal OS (e.g., non-secure OS), and the TEE 320 may be driven in a secure OS. The normal OS may be, for example, an android OS, and the secure OS may be, for example, teegris, QSEE, or trustzone. The secure OS is separated independently of the normal OS, and it may be an environment in which it operates based on a separate resource and thus it is unable to be accessed by an unpermitted program or application. For example, the electronic device 101 may create virtual cores, and a first virtual core may drive the normal OS, while a second virtual core may drive the secure OS.

In the environment of the TEE 320, the electronic device 101 may encrypt data based on a trusted application (TA) 331 being driven in the secure OS. In the environment of TEE 320, the electronic device 101 may perform the encryption with a separate memory (e.g., eSE or eSIM) space that is different from the normal OS, and thus it can safely protect the data through comparison of the normal OS with a normal application 340 being driven in the normal OS. In the environment of the TEE 320, the electronic device 101 may perform encryption and decryption through the trusted application 331.

The TEE 320 may store data requiring a relatively high secure level in a safe environment, and it may perform a related operation. The TEE 320 may operate on the normal OS of the application processor of the electronic device 101, and it may operate based on a trustable hardware structure that is determined in a manufacturing process of the electronic device 101. The TEE 320 may operate on the secure OS of the application processor of the electronic device 101. The TEE 320 may configure software or hardware requiring the security to operate only in the secure world. The electronic device 101 may operate the TEE 320 through the physical change of the hardware or the logical change of the software.

The TEE 320 and the REE 310 may be separated from each other through hardwired contracts, and they may operate on the same hardware in a state where they are separated from each other by software. At least one application (e.g., digital wallet, transaction, or browser) operating in the REE 310 may use an API (e.g., TEE functional API 321 or REE client API 323) permitted to access the TEE 320. According to an embodiment, at least one application 340 operating in the REE 310 may be an application related to the block chain network or the distributed application.

The at least one application 340 (e.g., client application) operating in the REE 310 may transfer data (or message) from an REE communication agent (e.g., REE communication agent 315) to a TEE communication agent (e.g., TEE communication agent 325). The message may be implemented to be transferred only to the TEE 320 in hardware. According to an embodiment, the message may be a block chain message based on the distributed application or the application related to the block chain network.

The TEE communication agent 325 may receive and transfer the message to the trusted application (TA) 331 (e.g., DRM, secure transaction module, or block chain application) related to the message. The at least one trusted application 331 operating in the TEE 320 may process encrypted data. The trusted application 331 may perform a message related operation, and it may transfer the result of the operation to the REE communication agent 315 through the TEE communication agent 325. The REE communication agent 315 may transfer the result to at least one application (client application 340) operating in the REE.

According to an embodiment, the at least one trusted application 331 operating in the TEE 320 may be the block chain trusted application and the secure user interface application.

According to an embodiment, the electronic device 101 may operate, for example, and without limitation, one of a trustzone (TZ), TEEGRIS, and qualcomm secure execution environment (QSEE), or the like. For example, the trustzone may be a secure function implemented in hardware by an ARM series processor core of ARM Holdings plc, and it may be a technology to strengthen the system security of a mobile electronic device that is vulnerable to security due to the open-type operating system. For example, in the case of operating one processor in hardware, the electronic device 101 may operate the trustzone through temporal division of the processor into the REE and the TEE. Further, in the case of operating a set of a plurality of cores, the electronic device 101 may configure a first core to operate the REE and a second core to operate the TEE, respectively.

Hereinafter, for convenience of description, it is assumed that the digital signature environment based on the block core network is illustrated to be divided into the normal world and the secure world according to various embodiments.

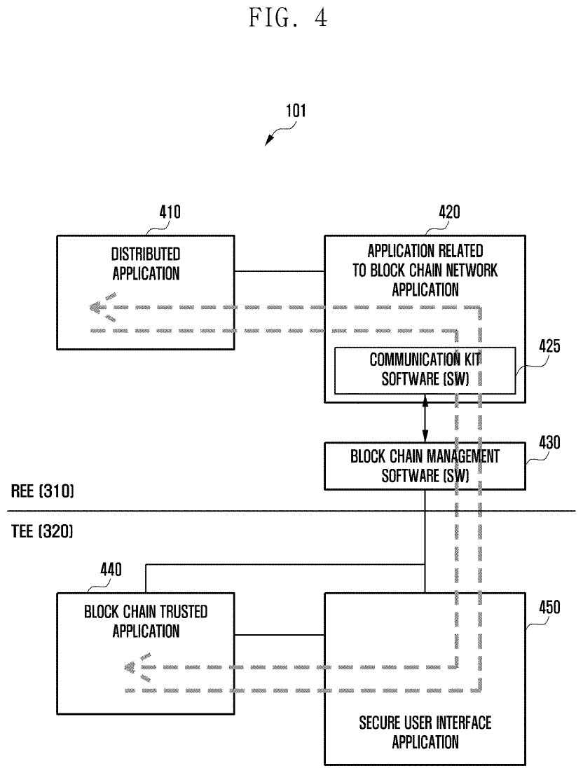

FIG. 4 is a diagram illustrating an example interface between elements of an electronic device for digital signature according to various embodiments.

With reference to FIG. 4, according to various embodiments, an electronic device (e.g., electronic device 101) may support a digital signature service during an access to a block chain network or transactions based on a normal world (e.g., REE) and a secure world (e.g., TEE) of FIG. 3. The normal world may refer, for example, to a world being operated in the case of being driven by a normal OS, and the secure world may refer, for example, to a world being operated in the case of being driven by a secure OS.

According to an embodiment, the normal world 310 may include a distributed application 410, an application 420 related to the block chain network, and block chain management software 430. The secure world 320 may include a block chain trusted application 440 and a secure user interface application 450. For example, the distributed application 410 and the application 420 related to the block chain network may be the client application 340 being driven in the REE 310 of FIG. 3, and the block chain trusted application 440 and the secure user interface application 450 may be the trusted application (TA) 331 being driven in the TEE 320 of FIG. 3.

The distributed application 410 may be an application being driven in a block chain platform or an ethereum network platform. For example, the distributed application 410 may be a block chain service application (e.g., decentralized application (Dapp)). The distributed application 410 may be configured as at least one combination of HTML, CSS, and java script (e.g., web3js). Participants that take part in the distributed network (e.g., block chain network) may interact with other participants that take part in the distributed network through the distributed application 410.

The application 420 related to the block chain network may be a cryptocurrency wallet application interlocking with the distributed application 410 or a browser application connected to the block chain network.

According to an embodiment, the application 420 related to the block chain network may be a user interface application that provides information based on the block chain and interacts with a user. For example, the application 420 related to the block chain network may manage and use the cryptocurrency and it may reflect the changed information in the block chain in the cryptocurrency. The application 420 related to the block chain network may interlock with the block chain management software 430 being driven in the secure environment.

According to an embodiment, if the application 420 related to the block chain network is the cryptocurrency wallet application, the cryptocurrency wallet application may be of a cold wallet type that prevents and/or reduces network hacking and safely stores the cryptocurrency in an offline state.

According to an embodiment, the application 420 related to the block chain network may include communication kit software (e.g., extension kit) for exchanging a message with the block chain management software 430. For example, the communication kit software may be an application programming interface (API) capable of using the block chain management software. For example, the communication kit software may be in the form of an API (e.g., TEE functional API 321 or REE client API 323) permitted to access the TEE 320 of FIG. 3.

According to an embodiment, the block chain management software 430 may exchange a message with the communication kit software 425 (e.g., extension kit). The block chain management software 430 may transfer the message to the block chain trusted application 440 and the secure user interface application 450 in the secure world. The block chain management software 430 may be, for example, software (e.g., android package kit (APK) file) that is applied to a portable device, such as a smart phone. In an example of FIG. 4, although it is described that the block chain management software 430 operates in the REE 310, according to various embodiments, the block chain management software 430 may operate in the TEE 320.

According to an embodiment, the application 420 related to the block chain network may create a public key and a private key that are used in the block chain network by applying an encryption algorithm based on a block chain message. The block chain network may identify participant account or address information through the public key, and it may verify the participant account through the private key.

According to an embodiment, when the block chain service account is created, the application 420 related to the block chain network may create the public key and the private key that are used in the block chain network by applying the encryption algorithm based on the user's personal information configured in the electronic device 101 and the block chain message. The user's personal information may be, for example, and without limitation, at least one of password configuration information, fingerprint authentication information, iris authentication information, face authentication information, pattern authentication information, or the like, but it is not limited thereto.

According to an embodiment, the public key and the private key may be created through the block chain trusted application 440, and they may be stored (or written) in the block chain management software 430 of the secure world.

The secure user interface application 450 may configure a user authentication request screen based on the block chain message in the secure world. The user authentication request screen may include, for example, and without limitation, at least one of host information of a service using the block chain network or a block chain application program, a block chain message, an authentication means object, or the like. The authentication means object may include, for example, and without limitation, at least one of a password input item, a fingerprint input item, an iris input item, a face recognition input item, an identification input item, or the like, in accordance with the configuration, but it is not limited thereto.

According to an embodiment, the secure user interface application 450 may configure a first user authentication request screen based on the host information and the message, and if a user approval input is received, it may configure a second user authentication request screen including the authentication means object for the digital signature. For example, the authentication means object included in the second user authentication request screen may be an object for receiving an input of the configured user's personal information when the cryptocurrency wallet account is created.

According to an embodiment, the secure user interface application 450 may configure the host information, the message, and the authentication means object for receiving the input of the configured user's personal information in one screen.

The block chain trusted application 440 may process the block chain data. As an example, the block chain trusted application 440 may hold and manage the cryptocurrency, and it may create the digital signature for smart contracts. The block chain trusted application 440 may create the digital signature for the block chain message transferred through the block chain management software 430, and it may transfer the digitally signed message to the block chain management software 430.

According to an embodiment, the block chain trusted application 440 may create the digital signature using the private key stored in the secure world. The digitally signed message may include at least one of a digital signature based on an inherent private key of the electronic device, information on a signer having created the digital signature, algorithm information used to create the digital signature, block identification information for identifying the block, or transaction information for identifying the transaction.

According to an embodiment, the block chain trusted application 440 may create digital signature for the block chain message based on the private key using, for example, elliptic curve cryptography (ECC). For example, the digitally signed data may include a value for verifying address information of the subject having signed in the distributed network (e.g., ethereum network) in addition to a parameter value (or hash value) being used in the elliptic curve cryptography. According to an embodiment, the block chain trusted application 440 may create the digital signature on the signature authentication request message if the user authentication input information coincides with the user's personal information in the case where the user's personal information is configured as a password during the creation of the private key.

The message digitally signed by the block chain trusted application 440 may be transferred to the application 420 related to the block chain network through the block chain software, and it may be transmitted to the block chain network through the distributed application 410.

Hereinafter, explanation will be made on the assumption that the application 420 related to the block chain network is a wallet application (e.g., cryptocurrency wallet application). However, the application related to the block chain network may include a browser application or a payment application. Further, the application 420 related to the block chain network may be an application that uses communication kit software capable of communicating with the secure OS.

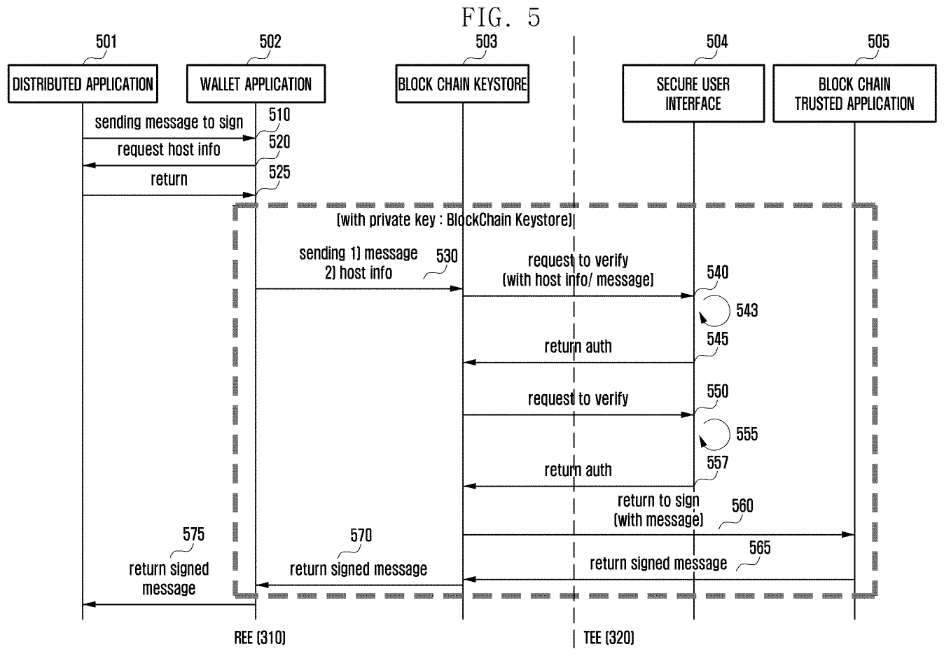

FIG. 5 is a signal flow diagram illustrating example data flow for a block chain based digital signature service of an electronic device according to various embodiments.

With reference to FIG. 5, according to various embodiments, a processor (e.g., processor 240 of FIG. 2) of an electronic device (e.g., electronic device 101) may create a digital signature on a block chain message by processing data between a distributed application 501 (e.g., distributed application 410 of FIG. 4) operating in a normal world (e.g., REE 310 of FIGS. 3 and 4), a wallet application 502 (e.g., application 420 related to a block chain network of FIG. 4), and a block chain keystore 503 (e.g., block chain management software 430 of FIG. 4), and a secure user interface 504 (e.g., secure user interface application of FIG. 4) operating in a secure world (e.g., TEE 320 of FIGS. 3 and 4) and a block chain trusted application 505 (e.g., block chain trusted application 440 of FIG. 4). For example, the processor may drive the distributed application 501, the wallet application 502, and the block chain keystore 503 in a normal OS, and it may drive the secure user interface 504 and the block chain trusted application 505 in a secure OS.

Hereinafter, although it is illustrated that the subjects of operations for data flows of the electronic device 101 are the distributed application 501, the wallet application 502, the block chain keystore 503, the secure user interface 504, and the block chain trusted application 505, this is merely for convenience in explanation, and the respective operations may be controlled by the processor of the electronic device.

At operation 510, under the control of the processor of the electronic device 101, the distributed application 501 may transfer a signature request message from a distributed network to the wallet application 502.

At operation 520, under the control of the processor, the wallet application 502 may request host information supporting the distributed network from the distributed application 501. For example, the host information may be host information of a service using the block chain network or an application program.

At operation 525, under the control of the processor, the distributed application 501 may provide the host information (e.g., URL information, Dapp name, host name, and the like) supporting the distributed network to the wallet application 502 in response to the request. According to an embodiment, operations 520 and 525 may be omitted, but they are not limited thereto.

At operation 530, the wallet application 502 may transfer at least one of a digital signature request message or the host information to the block chain keystore 503.

According to an embodiment, the wallet application 502 may support connection between a block chain network platform and the electronic device 101, and it may include communication kit software (e.g., extension kit) for communication with the block chain keystore 503. The block chain keystore 503 may exchange a message through the communication kit software included in the wallet application 502.

According to an embodiment, if there is a public key previously shared between the distributed application 501 or the service operating the distributed application and the block chain keystore 503, the distributed application 501 or the service operating the distributed application 501 may transfer a digitally signed message to the block chain keystore 503. The block chain keystore 503 may identify whether the transferred message is a message transmitted from a trustable host based on the digitally signed message transferred from the distributed application 501 or the service operating the distributed application 501. For example, because the distributed application 501 or the service operating the distributed application 501 previously provides the digitally signed message to the block chain keystore 503 using the public key and the private key, the block chain keystore 503 may identify and trust the message transmitted from the distributed application 501 or the service operating the distributed application 501. The public key and the private key used for the digital signature by the distributed application 501 or the service operating the distributed application 501 may be different from a private key and a public key for digital signature by the block chain trusted application 505.

At operation 540, under the control of the processor, the block chain keystore 503 may transfer a request message for identifying the host information to the secure user interface 504. Under the control of the processor, the secure user interface 504 may identify the host information for the block chain network in a secure OS, and it may configure a first user authentication request screen for receiving an access approval to display the configured screen. The first user authentication request screen may be a screen for requesting a user to identify an access to the block chain network and to identify the digital signature for block information (or transaction)/transaction information. The first user authentication request screen may be configured to include a message, host information, and an input identification object.

At operation 543, the secure user interface 504 may receive a user input including the input identification object.

At operation 545, the secure user interface 504 may transfer approval information on the input identification to the block chain keystore 503.

At operation 550, under the control of the processor, the block chain keystore 503 may transfer an authentication request for the digital signature to the secure user interface 504. The secure user interface 504 may configure a second user authentication request screen for the user to identify the digital signature for the block chain message in the secure OS, and it may display the configured screen. The second user authentication request screen may include at least one of a message for requesting an input of user's personal information configured for the user authentication or an authentication means object. The authentication means object may include, for example, and without limitation, an object for authenticating at least one of a configured password authentication, fingerprint authentication, iris authentication, face authentication, pattern authentication, or the like. For example, the user's personal information may be password information configured during creation of a cryptocurrency wallet application account. The user may input the user's personal information corresponding to the authentication means object.

According to an embodiment, the electronic device 101 may omit operations 540, 543, and 545, and if the operations 540, 543, and 545 are omitted, the electronic device 101 may provide the user with the user authentication request screen including the host information, the message, and the authentication means object, and based on this, the electronic device 101 may receive user authentication input information.

At operation 555, the secure user interface 504 may receive the user input from the authentication means object included in the user authentication request screen configured in the secure OS.

At operation 557, the secure user interface 504 may transfer the user authentication information to the block chain keystore 503 in response to the user input information.

At operation 560, the block chain keystore 503 may request the digital signature for the request message from the block chain trusted application 505 in response to the user authentication information. The block chain trusted application 505 may create the digital signature for the request message based on the private key stored in the memory of the secure OS. The digitally signed message may include, for example, and without limitation, at least one of a digital signature based on an inherent private key of the electronic device, information on a signer having created the digital signature, algorithm information used to create the digital signature, block identification information for identifying a block, transaction information for identifying a transaction, or the like.

At operation 565, the block chain trusted application 505 may transfer the digitally signed message to the block chain keystore 503. At operation 570, the block chain keystore 503 may transfer the digitally signed message to the wallet application 502. The block chain keystore 503 may transfer the digitally signed message to the wallet application 502 through communication kit software included in the wallet application 502.

At operation 575, the wallet application 502 may transfer the digitally signed message to the distributed application 501.

The electronic device 101 may control to identify the result of verification of a user account for the digitally signed message through the distributed application 501, and it may control to use the distributed network service.

According to various example embodiments, an electronic device (e.g., electronic device 101 of FIGS. 1 and 2) may include a communication circuit (e.g., communication module 190 of FIG. 1 or communication circuit 220 of FIG. 2) configured to wirelessly communicate with an external electronic device; a display (e.g., display device 160 of FIG. 1 or display 210 of FIG. 2); a memory (e.g., memory 130 of FIG. 1 or memory 230 of FIG. 2); and at least one processor (e.g., processor 120 of FIG. 1 or processor 240 of FIG. 2) electrically connected to the communication circuit, the display, and the memory, wherein the at least one processor is configured to operate a normal OS (e.g., REE 310 of FIGS. 3 and 4) and a secure OS (TEE 320 of FIGS. 3 and 4), and the memory stores instructions which, when executed, cause the at least one processor to control the electronic device to: receive a signature request message corresponding to a block chain through the communication circuit in the normal OS, drive block chain management software (e.g., block chain management module 245 of FIG. 2 or block chain management software 430 of FIG. 4) in response to receiving the signature request message, transfer the signature request message to the secure OS through the block chain management software, configure a user authentication request screen based on a trusted application (e.g., trusted application of FIG. 3, block chain trusted application 440 of FIG. 4, or secure user interface application 450 of FIG. 4) being driven in the secure OS to output the user authentication request screen to the display, create a digital signature on the signature request message in the secure OS reflecting a private key stored in the memory in response to receiving a user authentication input for the digital signature, and transfer the digitally signed message to an application (e.g., application 420 related to the block chain network of FIG. 4 or wallet application 502 of FIG. 5) related to a block chain network operating in the normal OS through the block chain management software.

According to an example embodiment, the instructions may, when executed, cause the at least one processor to control the electronic device to: transfer a signature authentication request message transferred to the application related to the block chain network to the secure OS through the block chain management software during transactions with another node taking part in the block chain network, and create the digital signature using the private key stored in the memory in the secure OS based on receiving the signature request message.

According to an example embodiment, the application related to the block chain network may further include communication kit software (e.g., communication kit software 425 of FIG. 4) for exchanging a message with the secure OS, and the signature request message and the digitally signed message may be exchanged by the communication kit software and the block chain management software.

According to an example embodiment, the trusted application being driven in the secure OS may include instructions to: interlock with the application related to the block chain network to store a private key being used for cryptocurrency authentication in the memory being operated during the secure OS, and create the digitally signed message by creating the digital signature on the signature request message through reflection of the stored private key by executing the trusted application being driven in the secure OS.

According to an example embodiment, the application related to the block chain network may include at least one of a wallet application, a payment application, or a browser application, and the instructions may, when executed, cause the at least one processor to control the electronic device to: create a pair of a public key and a private key based on the block chain during creation of an account of the block chain network, transfer the public key to another node taking part in the block chain network, and store the private key in a secure region of the memory.

According to an example embodiment, the instructions may, when executed, cause the at least one processor to control the electronic device to: create a public key and a private key by applying an encryption algorithm based on user's personal information configured in the electronic device and a block chain message through the trusted application being driven in the secure OS, and create the digital signature on a signature authentication request message based on the user authentication input information coinciding with the user's personal information.

According to an example embodiment, the instructions may, when executed, cause the at least one processor to control the electronic device to: operate the trusted application being driven in the secure OS in one of a trusted execution environment (TEE), a TEEGRIS, a qualcomm secure execution environment (QSEE), or a trustzone.

According to an example embodiment, the block chain management software may be an application program based on an open OS that is built or installed in the electronic device, or that is downloaded through an app store.

According to an example embodiment, the application related to the block chain network may store instructions to: request host information of a service using the block chain network or a block chain application program through communication with a distributed application connected to the block chain network, and transfer block chain host information transferred from the block chain network to the secure OS.

According to an example embodiment, the instructions may, when executed, cause the at least one processor to control the electronic device to: configure the user authentication request screen to include at least one of the block chain network host information, a block chain message, or an authentication means object through the trusted application being driven in the secure OS, and the authentication means object may include at least one of a configured password authentication, fingerprint authentication, face authentication, pattern authentication, iris authentication, or input identification authentication.

According to an example embodiment, the instructions may further include instructions which, when executed, cause the at least one processor to control the electronic device to: configure a first user authentication request screen for identifying the host information through the trusted application being driven in the secure OS and receiving an access approval of the host information to output the first user authentication request screen to the display, and configure a second user authentication request screen including an authentication means object for requesting an input of user's personal information configured for user authentication in response to a user approval input to output the second user authentication request screen to the display, and the authentication means object includes at least one of a configured password authentication, fingerprint authentication, face authentication, pattern authentication, or iris authentication.

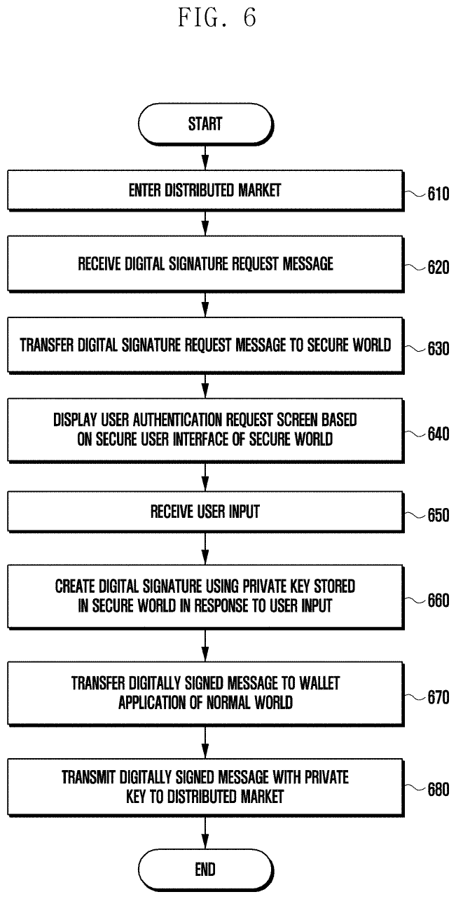

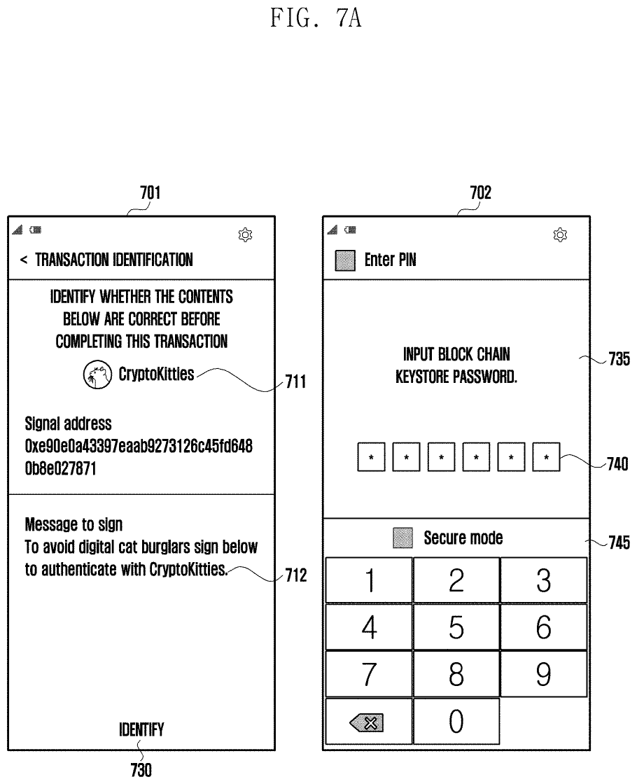

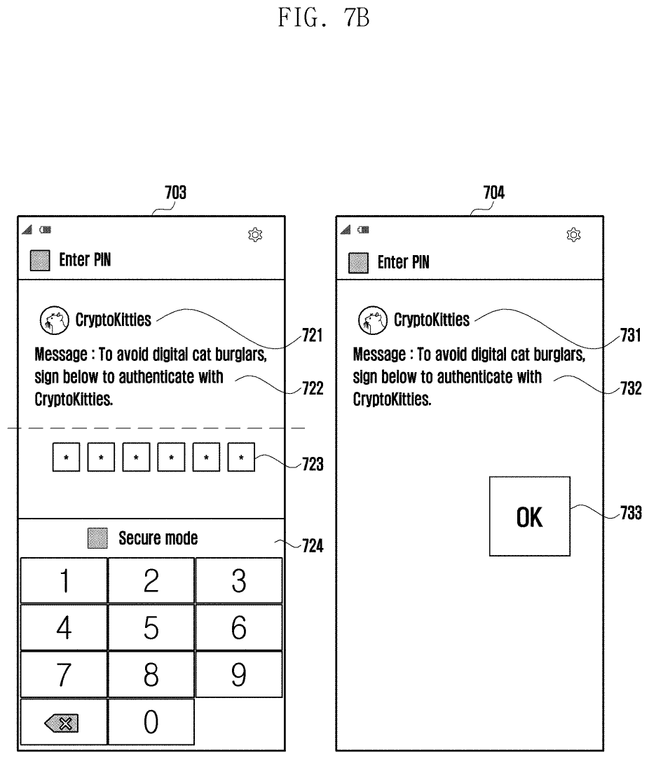

FIG. 6 is a flowchart illustrating an example method for a digital signature service based on a block chain of an electronic device according to various embodiments, and FIGS. 7A and 7B are diagrams illustrating examples of a digital signature authentication request screen of an electronic device according to various embodiments.

With reference to FIG. 6, according to various embodiments, at operation 610, a processor (e.g., processor 240 of FIG. 2) of an electronic device (e.g., electronic device 101) may request to enter a distributed market in response to a user request. The distributed market may be a market based on a block chain network or an ethereum network. For example, the electronic device 101 may access a web page for the distributed market through a web browser. According to an embodiment, operation 610 may be omitted.

At operation 620, the processor of the electronic device 101 may receive a digital signature request message for user verification from the block chain network through a communication circuit.

As an example, if a participant accesses a block chain (or ethereum) client (e.g., another electronic device of another node) in a block chain network service, the participant may receive a message for requesting transmission of a signed identification message to identify an owner based on a user account. The block chain client may permit an access to data public to the block chain through the user account by identifying legality of the user account based on the signed identification message.

In addition, the processor of the electronic device 101 may request host information of a service using the block chain network or a block chain application program by controlling the communication circuit, and it may receive the host information from the block chain network. This operation has been omitted from FIG. 6.

At operation 630, the processor of the electronic device 101 may transfer the digital signature request message to a secure world. For example, the processor of the electronic device 101 may execute a secure user interface application and a block chain trusted application operating in the secure world by driving block chain management software. The processor of the electronic device 101 may control message exchange between communication kit software included in a wallet application and the block chain management software.

At operation 640, the processor of the electronic device 101 may display a user authentication request screen for the digital signature based on the secure user application of the secure world. The user authentication request screen may be implemented in a TEE, and information input through the user authentication request screen may be transferred to a TEE. As illustrated in FIG. 7A, it may be possible to receive a user input by providing the user authentication request screen in two stages, and as illustrated in FIG. 7B, it may also be possible to receive the user input by providing the user authentication request screen in one stage.

According to an embodiment illustrated in FIG. 7A, the electronic device may identify the host information for the block chain network, and it may output a first user authentication request screen 701 for receiving an access approval to the display. After a user approval input is received, the electronic device may output a second user authentication request screen 702 for authenticating the digital signature with respect to the block chain message to the display. For example, as illustrated in FIG. 7A, if the block chain message is received, the electronic device 101 may create the first user authentication request screen 701 in the secure OS, and it may output the created screen 701 to the display. The first user authentication request screen 701 may include host information 711 of the block chain network, a request message 712, and an identification input approval object 730. If the user selects the identification input approval object 730 through identification of the host information, the electronic device 101 may create the second user authentication request screen 702 in the secure OS, and it may output the created screen 702 to the display. The second user authentication request screen 702 may be configured to include a message 735 for requesting an input of the user's personal information configured for the user authentication and a password authentication object 740. In an embodiment of FIG. 7A, the second user authentication request screen 702 may be configured to further include a keypad 745 for inputting a password. The user may input the password input when the block chain network account is created through the password authentication object 740. The password authentication object 740 may be merely an example of the screen, and if another user's personal information, such as iris recognition information, fingerprint recognition information, face recognition information, pattern recognition information, or numeral authentication, is configured, an authentication means object based on the configured user's personal information may be implemented. If the input information input by the user on the second user authentication request screen coincides with the configured password, the processor of the electronic device may create the digital signature based on the private key stored in the secure world.

According to an embodiment of FIG. 7B, the electronic device 101 may configure the user authentication request screen so that the user authentication request screen includes the host information of the block chain network, the request message, and the authentication means object, and it may output the configured screen to the display. As an example, if the user's personal information configured when the account is created exists, the electronic device 101, as illustrated, may configure the user authentication request screen 703 to include host information 721 of the block chain network, a request message 722, and an authentication means object 723. The authentication means object 723 may differ depending on the configured user's personal information. If the user's personal information is configured through the password authentication, the user authentication request screen 703 may be configured to further include the keypad 724.

As another example, if the configured user's personal information does not exist, the electronic device may configure the user authentication request screen 704 to include host information 731 of the block chain network, a request message 732, and an identification object 733. The identification object 733 may be an object for identifying only user input approval without the user's personal information of the electronic device 101.

At operation 650, the processor of the electronic device 101 may receive the user input through the secure user interface being driven in the secure world. For example, through the user authentication screen, the user may perform, for example, and without limitation, at least one of password information, iris information, fingerprint information, face information, pattern information, approval identification, or the like.

At operation 660, the processor of the electronic device 101 may create the digital signature on the message using the private key stored in the secure world in response to the user input.

According to an embodiment, if the private key is created through configuration of the user's personal information, and the configured user's personal information coincides with the user's personal information input through the screen 701/702 of FIG. 7A or the screen 703 of FIG. 7B, the electronic device 101 may create the digital signature for the message based on the private key.

According to an embodiment, if the private key is created without the user's personal information, the electronic device 101 may output the screen 704 of FIG. 7B to the display, and it may create the digital signature for the message based on the private key in response to the reception of the approval identification input.

At operation 670, the processor of the electronic device 101 may transfer the digitally signed message to the wallet application of the normal world. At operation 680, the processor of the electronic device 101 may transmit the message digitally signed with the private key to the distributed market.

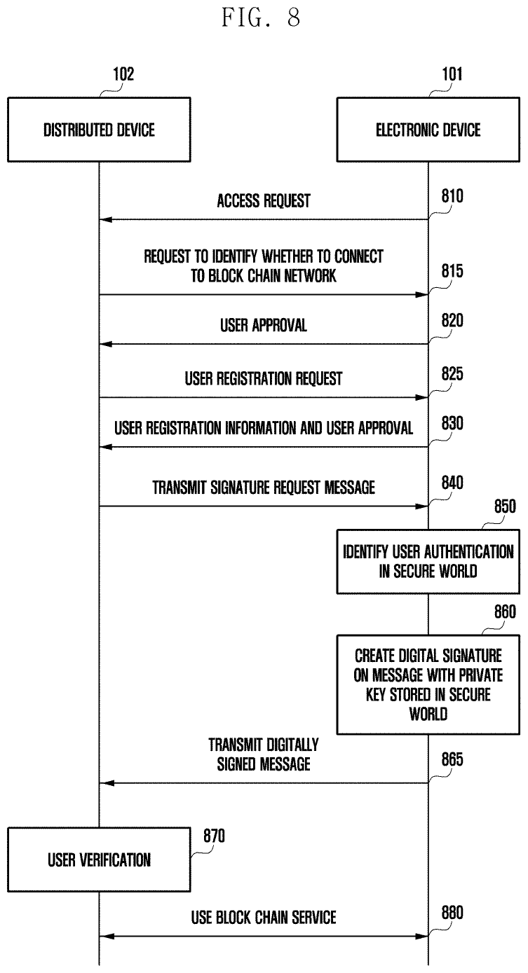

FIG. 8 is a signal flow diagram illustrating example operations between a distributed network device and an electronic device according to various embodiments.

With reference to FIG. 8, according to various embodiments, an electronic device (e.g., electronic device 101 of FIG. 1 or electronic device 101 of FIG. 2) and a distributed device 102 may communicate with each other based on the block chain network. The distributed device 102 may, for example, be an electronic device of another node that takes part in the block chain network through a distributed application.

At operation 810, the electronic device may transmit an access request for the block chain connected to the distributed device 102 to the distributed device 102.

At operation 815, the distributed device 102 may request the electronic device 101 to identify whether to connect to the block chain network through the account information of the electronic device 101 in response to the access request of the electronic device 101. The electronic device 101 may output the information requested from the distributed device 102 to the display, and it may receive an approval input from the user at operation 820.

At operation 825, the distributed device 102 may transmit a request for registration of a user of the block chain network to the electronic device 101 in response to the connection approval to the account information of the electronic device 101. The electronic device 101 may output information on the user registration request to the display, and it may receive the user registration information and the user approval input.

At operation 830, the electronic device 101 may transmit the user registration information and the user approval information to the distributed device 102. As an example, operations 825 and 830 may be operations that are performed during an initial access to the block chain network, and operations 820 and 830 after the user registration may be omitted.

At operation 840, the distributed device 102 may transmit a signature request message to the electronic device 101 to verify whether the electronic device is a block chain participant.

As an example, the electronic device 101 may perform message exchange between the normal world and the secure world by driving the cryptocurrency wallet application and the block chain management software. The cryptocurrency wallet application may include communication kit software (e.g., extension kit) for the message exchange with the block chain management software 430.

According to an embodiment, the electronic device 101 may transmit a public key corresponding to an account to the distributed device 102 when the cryptocurrency wallet application creates the account. The distributed device 102 may store the public key corresponding to the electronic device account. For example, public key information for all nodes taking part in the block chain network may be stored in a block chain database.

At operation 850, the electronic device 101 may identify the user authentication input in the secure world. If the signature request message is received, the electronic device 101 may output the user authentication request screen created in the secure world to the display through driving of the block chain management software, and it may receive the user authentication input from the user. The user authentication input received in the secure world may be encrypted to be processed.

At operation 860, the electronic device 101 may create the digitally signed message through creation of the digital signature for the message based on the private key stored in the secure world. A digital signature algorithm for creating the digital signature on the message may be applied to the digitally signed message. For example, the digital signature algorithm may be an elliptic curve cryptography algorithm, but it is not limited thereto. The digital signature algorithm may apply the private key to the message.

At operation 865, the electronic device 101 may transfer the digitally signed message to the distributed device 102. At operation 870, the distributed device 102 may perform user verification based on the digital signature included in the message, and it may permit an access performed by the electronic device 101. The private key and the public key may constitute a pair, and the distributed device 102 may verify the private key through comparison with the public key based on the private key.

As an example, the distributed device 102 may extract a parameter value (or hash value) from the message digitally signed with the private key, extract a signer address (e.g., account information) through a decryption process of the elliptic curve cryptography algorithm, and verify whether the electronic device is a rightful participant authenticated in the block chain network through the value for verifying the address information of the subject having signed among the extracted information. For example, the distributed device 101 may recover the address related to the public key through an ecrecover (e.g., MSG, r, s, v) function supported by default in solidity (smart contract preparation language) in the block chain network, and it may verify the participant's account based on the recovered address.

At operation 880, if the access approval is completed by the distributed device 102, the electronic device 101 may use the block chain service by accessing the block chain through the distributed device.

According to various example embodiments, a method for a digital signature service based on a block chain of an electronic device (e.g., electronic device 101 of FIGS. 1 and 2) may include receiving, by a processor (e.g., processor 120 of FIG. 1 or processor 240 of FIG. 2) of the electronic device, a signature request message corresponding to the block chain through a communication module in a normal OS (e.g., REE 310 of FIGS. 3 and 4); driving block chain management software (e.g., block chain management module 245 of FIG. 2 or block chain management software 430 of FIG. 4) in response to receiving the signature request message; transferring the signature request message from the normal OS to a secure OS (e.g., TEE 320 of FIGS. 3 and 4) through the block chain management software; configuring a user authentication request screen corresponding to the signature request message through a trusted application (e.g., trusted application of FIG. 3, block chain trusted application 440 of FIG. 4, or secure user interface application 450 of FIG. 4) being driven in the secure OS to output the user authentication request screen to a display (e.g., display device 160 of FIG. 1 or display 210 of FIG. 2); receiving a user authentication input for a digital signature; creating the digital signature on the signature request message reflecting a private key in the electronic device in response to receiving the user authentication input in the secure OS; and transferring the digitally signed message to an application (e.g., wallet application 420 related to a block chain network of FIG. 4 or wallet application 502 of FIG. 5) related to the block chain network operating in the normal OS through the block chain management software, wherein the secure OS is configured to operate separately from the normal OS under the control of the processor.

According to an example embodiment, receiving the signature request message may further include: transferring the signature request message from a distributed application for accessing the block chain network or the block chain network to the application related to the block chain network in the normal OS; and transferring the signature request message from the application related to the block chain network to the secure OS through the block chain management software.

According to an example embodiment, creating the digital signature may create the digital signature on a message being transferred based on an access to the block chain network, block information identification, or a transaction being performed.

According to an example embodiment, the application related to the block chain network may further include communication kit software for exchanging a message with the block chain management software, and driving the block chain management software may further include exchanging the message between the block chain management software and the communication kit software.

According to an example embodiment, driving the block chain management software may further include creating a pair of a public key and a private key based on the block chain based on the processor of the electronic device creating a block chain account in interlock with the application related to the block chain network in the secure OS through the trusted application being driven in the secure OS; transferring the public key to a cryptocurrency wallet application so that the public key is transferred to the block chain network; and storing the private key in a memory being operated during the secure OS.

According to an example embodiment, creating the digital signature on the signature request message may create the digital signature using a private key based on information on the user authentication input coinciding with user's personal information configured in the electronic device in the case where a public key and the private key are created based on the user's personal information and block chain information.

According to an example embodiment, receiving the signature request message corresponding to the block chain may further include: requesting, by the processor of the electronic device, host information of a service using the block chain network or a block chain application program in the normal OS; and transferring the block chain host information received from the block chain network to the secure OS through the block chain management software.

According to an example embodiment, the user authentication request screen may include at least one of the block chain network host information, a block chain message, or an authentication means object, and the authentication means object may include at least one of a configured password authentication, fingerprint authentication, iris authentication, face authentication, pattern authentication, or input identification authentication.

According to an example embodiment, configuring and outputting the user authentication request screen to the display may further include: outputting a first user authentication request screen for identifying the host information and receiving an access approval of the host information; receiving a user approval input through the first user authentication request screen; and outputting a second user authentication request screen including an authentication means object for requesting an input of user's personal information configured for user authentication in response to receiving the user approval input, and the authentication means object may include at least one of a configured password authentication, fingerprint authentication, face authentication, pattern authentication, or iris authentication.

The various example embodiments of the disclosure and the terms used in the embodiments are not intended to limit the technology described in this document to a specific embodiment, but should be understood as including various changes, equivalents and/or alternatives of a corresponding embodiment. Regarding the description of the drawings, similar reference numerals may be used in similar elements. An expression of the singular number may include an expression of the plural number unless clearly defined otherwise in the context.

The “module” used in the disclosure includes a unit configured with hardware, software or firmware, and may be interchangeably used with a term, such as logic, a logical block, a part or a circuit. The module may be an integrated part, a minimum unit to perform one or more functions, or a part thereof. For example, the module may be configured with an application-specific integrated circuit (ASIC).

The various embodiments of the disclosure may be implemented as software (e.g., program 140) including instructions stored in a machine (e.g., electronic device 101)-readable storage medium (e.g., internal memory 136 or external memory 138). For example, a processor (e.g., processor 120) of a device (e.g., electronic device 101) may fetch and execute at least one of instructions stored in the storage medium, and this enables the device to perform at least one function according to the fetched instructions. At least one of the instructions may include a code generated by a compiler or a code executable by an interpreter. The machine-readable storage medium may be provided in the form of a non-transitory storage medium. In this case, the “non-transitory” storage media may not include a signal (e.g., electromagnetic waves) and is tangible, and is not limited to whether data is stored in the storage media semi-permanently or temporally.

According to an embodiment, the method according to various embodiments disclosed in the disclosure may be included in a computer program product and provided. The computer program product may be traded as a product between a seller and a purchaser. The computer program product may be online distributed (e.g., downloaded or uploaded) in the form of device-readable storage media (e.g., compact disc read only memory (CD-ROM)) or through an app store (e.g., PlayStore™) or directly between two user devices (e.g., smart phones). In the case of the online distribution, at least some of the computer program product may be at least temporarily stored or temporally generated in storage media, such as the memory of the server of a manufacturer, the server of an app store or a relay server.

Although various example embodiments of the disclosure have been illustrated and described herein, these are merely examples, and are not limiting, and do not limit the scope of the present disclosure. Accordingly, it should be understood that all modifications or modified types derived based on the disclosure are included in the scope of the disclosure in addition to the embodiments disclosed herein.

What is claimed is:

1. An electronic device comprising:
a communication circuit configured to communicate with an external electronic device;
a display;
a memory; and
at least one processor electrically connected to the communication circuit, the display, and the memory,
wherein the at least one processor is configured to operate a normal OS and a secure OS, and
the memory stores instructions which, when executed, cause the at least one processor to control the electronic device to:
receive a signature request message corresponding to a block chain through the communication circuit in the normal OS,
drive block chain management software in response to receiving the signature request message,
transfer the signature request message to the secure OS through the block chain management software,
configure a user authentication request screen based on a trusted application being driven in the secure OS to output the user authentication request screen to the display,
create a digital signature on the signature request message in the secure OS reflecting a private key stored in the memory in response to receiving a user authentication input for the digital signature, and
transfer the digitally signed message to an application related to a block chain network in the normal OS through the block chain management software.

2. The electronic device of claim 1, wherein the instructions, when executed, cause the at least one processor to control the electronic device to:
transfer a signature authentication request message transferred to the application related to the block chain network to the secure OS through the block chain management software during transactions with another node taking part in the block chain network, and
create the digital signature using the private key stored in the memory in the secure OS based on receiving the signature request message.

3. The electronic device of claim 1, wherein the application related to the block chain network further comprises communication kit software for exchanging a message with the secure OS, and
the signature request message and the digitally signed message are configured to be exchanged by the communication kit software and the block chain management software.

4. The electronic device of claim 1, wherein the trusted application being driven in the secure OS comprises instructions to:
interlock with the application related to the block chain network to store a private key being used for cryptocurrency authentication in the memory being operated during the secure OS, and create the digitally signed message by creating the digital signature on the signature request message reflecting the stored private key by executing the trusted application being driven in the secure OS.

5. The electronic device of claim 4, wherein the application related to the block chain network comprises at least one of a wallet application, a payment application, or a browser application, and
the instructions, when executed, cause the at least one processor to control the electronic device to:
create a pair of a public key and a private key based on the block chain based on creation of an account of the block chain network, transfer the public key to another node taking part in the block chain network, and store the private key in a secure region of the memory.

6. The electronic device of claim 1, wherein the instructions, when executed, cause the at least one processor to control the electronic device to:
create a public key and a private key by applying an encryption algorithm based on user's personal information configured in the electronic device and a block chain message through the trusted application being driven in the secure OS, and
create the digital signature on a signature authentication request message based on the user authentication input information coinciding with the user's personal information.

7. The electronic device of claim 1, wherein the instructions, when executed, cause the at least one processor to control the electronic device to: operate the trusted application being driven in the secure OS in one of a trusted execution environment (TEE), a TEEGRIS, a qualcomm secure execution environment (QSEE), or a trustzone.

8. The electronic device of claim 1, wherein the block chain management software includes an application program based on an open OS built or installed in the electronic device, or downloaded through an app store.

9. The electronic device of claim 1, wherein the application related to the block chain network stores instructions to:
request host information of a service using the block chain network or a block chain application program through communication with a distributed application connected to the block chain network, and transfer block chain host information transferred from the block chain network to the secure OS.

10. The electronic device of claim 9, wherein the instructions, when executed, cause the at least one processor to control the electronic device to: configure the user authentication request screen to include at least one of the block chain network host information, a block chain message, or an authentication means object through the trusted application being driven in the secure OS, and
the authentication means object includes at least one of a configured password authentication, fingerprint authentication, face authentication, pattern authentication, iris authentication, or input identification authentication.

11. The electronic device of claim 9, wherein the instructions further comprise instructions which, when executed, cause the at least one processor to control the electronic device to: configure a first user authentication request screen for identifying the host information through the trusted application being driven in the secure OS and receiving an access approval of the host information to output the first user authentication request screen to the display, and configure a second user authentication request screen including an authentication means object for requesting an input of user's personal information configured for user authentication in response to a user approval input to output the second user authentication request screen to the display, and
the authentication means object includes at least one of a configured password authentication, fingerprint authentication, face authentication, pattern authentication, or iris authentication.

12. A method for a digital signature service based on a block chain of an electronic device, the method comprising:
receiving, by the electronic device, a signature request message corresponding to the block chain through a communication module in a normal OS;
driving block chain management software in response to receiving the signature request message;
transferring the signature request message from the normal OS to a secure OS through the block chain management software;
configuring a user authentication request screen corresponding to the signature request message through a trusted application being driven in the secure OS to output the user authentication request screen to a display;
receiving a user authentication input for a digital signature;
creating the digital signature on the signature request message reflecting a private key stored in the electronic device in response to receiving the user authentication input in the secure OS; and
transferring the digitally signed message to an application related to a block chain network operating in the normal OS through the block chain management software,
wherein the secure OS is configured to operate separately from the normal OS under the control of the processor.

13. The method of claim 12, wherein receiving the signature request message further comprises:
transferring the signature request message from a distributed application for accessing the block chain network or the block chain network to the application related to the block chain network in the normal OS; and
transferring the signature request message from the application related to the block chain network to the secure OS through the block chain management software.

14. The method of claim 12, wherein creating the digital signature includes creating the digital signature on a message being transferred based on an access to the block chain network, block information identification, or a transaction being performed.

15. The method of claim 12, wherein the application related to the block chain network further comprises communication kit software for exchanging a message with the block chain management software, and
driving the block chain management software further includes exchanging the message between the block chain management software and the communication kit software.

16. The method of claim 12, wherein driving the block chain management software further comprises:
creating a pair of a public key and a private key based on the block chain based on the processor of the electronic device creating a block chain account interlocking with the application related to the block chain network in the secure OS through the trusted application being driven in the secure OS;
transferring the public key to a cryptocurrency wallet application to transfer the public key to the block chain network; and
storing the private key in a memory operated during the secure OS.

17. The method of claim 12, wherein creating the digital signature on the signature request message includes creating the digital signature using a private key based on information on the user authentication input coinciding with user's personal information configured in the electronic device based on a public key and the private key being created based on the user's personal information and block chain information.

18. The method of claim 12, wherein receiving the signature request message corresponding to the block chain further comprises:
requesting, by the electronic device, host information of a service using the block chain network or a block chain application program in the normal OS; and
transferring the block chain host information received from the block chain network to the secure OS through the block chain management software.

19. The method of claim 18, wherein the user authentication request screen comprises at least one of the block chain network host information, a block chain message, or an authentication means object, and
the authentication means object includes at least one of a configured password authentication, fingerprint authentication, iris authentication, face authentication, pattern authentication, or input identification authentication.

20. The method of claim 18, wherein configuring and outputting the user authentication request screen to the display further comprises:
outputting a first user authentication request screen for identifying the host information and receiving an access approval of the host information;
receiving a user approval input through the first user authentication request screen; and
outputting a second user authentication request screen including an authentication means object for requesting an input of user's personal information configured for user authentication in response to receiving the user approval input, and
the authentication means object includes at least one of a configured password authentication, fingerprint authentication, face authentication, pattern authentication, or iris authentication.
